(19) United States
(12) Patent Application Publication
(10) Pub. No.: US 2023/0136401 A1
(43) Pub. Date: May 4, 2023

(54) IN-STORE MOBILE ORDERING SERVICE

(71) Applicant: NCR Corporation, Atlanta, GA (US)

(72) Inventors: Zachary Taylor Lasater, Atlanta, GA (US); Zachary Christopher DeBardlebon, Atlanta, GA (US)

(21) Appl. No.: 17/513,481

(22) Filed: Oct. 28, 2021

(51) Int. Cl. G06Q 30/06; G06Q 10/08; G06Q 10/06; G06Q 30/02; G07C 11/00; G06F 9/54

(52) U.S. Cl. CPC G06Q 30/0635; G06Q 30/0617; G06Q 10/087; G06Q 10/06315; G06Q 30/0639; G06Q 30/0281; G07C 11/00; G06F 9/541; G07C 2011/04

(57) ABSTRACT

A customer order is received and associated with a list of items being ordered from an in-store counter of a store. An estimated time of preparing the order by attendants of the in-store counter is calculated. The customer selects a time to pickup the order after presented with the estimated required time to fulfill and prepare the order. The order is placed on behalf of the customer with the store. Status updates for the order are sent to the customer on a customer-operated device. Once the status of the order indicates the order is completed, the customer travels to the in-store counter within the store and picks up the order.

### BACKGROUND

In-store customer assistance counters are popular and common in retail stores. Some of these counters include bakeries, delis, take out and prepared specialty food items, coffees/drinks, photos, custom printings, and others.

Often customers are at a given store to purchase other items in the store, which they can pick from the shelves and place in their baskets/carts. Customers are encouraged to take a number for purposes of securing their spot in a queue for assistance of their specialty goods at the customer assistance counters. The customers must stay around the general vicinity of the counters within the store while they wait for their service numbers to be called because if the customers are not around to hear their numbers when called, the attendant will move to the next number in the queue and the customers that left will have to repeat the process to be successfully waited on at the counters.

There are many inefficiencies associated with the customer-assistance counters and their existing procedures. Customers become frustrated as they are forced to wait in line until their number is called in order to place their orders. Once the orders are placed, the customers must further wait for their orders to be prepared and delivered to them. The longer a customer is waiting to place their order, the more agitated and frustrated the customer becomes. As a result, there is a substantial amount of customer wasted time, which can lead to customer dissatisfaction and negative reviews for the retailer.

Additionally, the attendants that work the counters have periods when there is no line and when there are no customers waiting to place orders, during which the attendants are idle. Lines can form at any moment in time during which the attendants are overwhelmed taking and fulfilling orders. As a result, the attendants have no ability to plan or manage the peak periods and idle periods of their workflows because attendants are not clairvoyant and see into the future or predict the contents of future orders.

### SUMMARY

In various embodiments, a system and methods for an in-store ordering service are provided.

According to an embodiment, a method for providing an in-store ordering service is presented. A mobile application of a mobile device for a customer is interacted with to obtain items associated with an order at an in-store counter of a store. An estimated completion time that the order is estimated to be fulfilled at the in-store counter is calculated. A desired time for pickup of the order is received from the customer through the mobile application. The order with the desired time is placed on behalf of the customer at a transaction terminal that is associated with the in-store counter. The customer is notified through the mobile application when a current status of the order changes to a completed status indicating that the order has been fulfilled and is ready for customer pickup at the in-store counter.

### BRIEF DESCRIPTION OF THE DRAWINGS

FIG. 1 is a diagram of a system for providing an in-store ordering service, according to an example embodiment.

FIG. 2 is a diagram of a method for providing an in-store ordering service, according to an example embodiment.

FIG. 3 is a diagram of another method for providing an in-store ordering service, according to an example embodiment.

### DETAILED DESCRIPTION

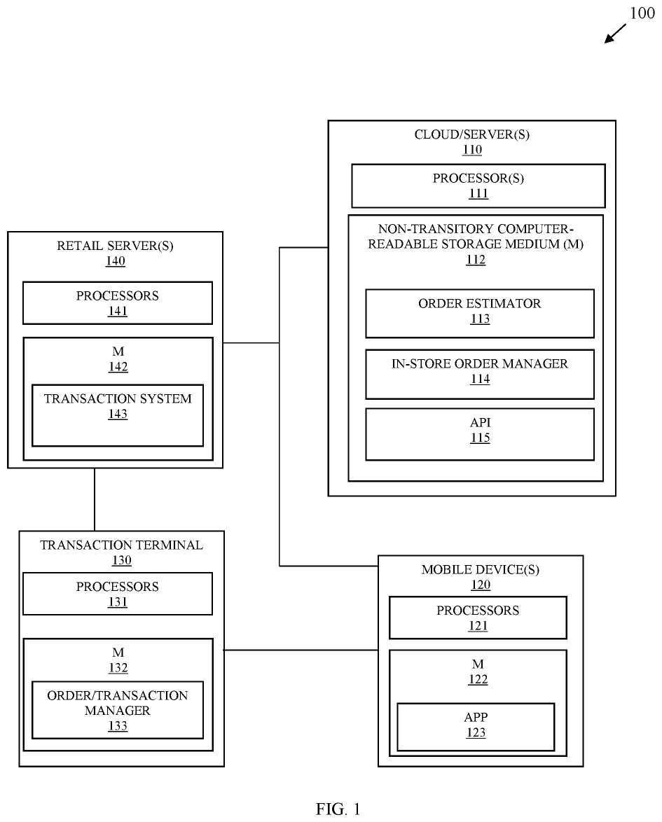

FIG. 1 is a diagram of a system/platform 100 for providing an in-store ordering service, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of providing an in-store ordering service, presented herein and below.

System/platform 100 (herein after just “system 100”) provides a processing environment by which customers can place orders in real time or through preprepared lists for in-store counter orders. The orders are delivered to the transaction terminals operated by the attendants of the counters and placed in an order pending work queue of the terminals. An estimated wait time for the order to be completed is provided to the customer. The customer may, optionally, specify a specific time for picking up the order or indicate that the order is needed as soon as possible (ASAP). The customer is free to shop about the store for any other items and go to the in-store counter and pickup their order at the designated time or when dynamically notified that the order is fulfilled. Updates may be sent directly to the customer's mobile device providing status updated for their pending order. This changes the traditional workflow and processes associated with placing and fulfilling orders at in-store counters.

As used herein, the terms “user,” “customer,” “shopper,” and/or “consumer,” may be used interchangeably and synonymously herein and below. This refers to an individual who is operating a mobile application of a mobile device to place orders with an in-store counter using an in-store ordering service discussed herein as system 100.

As used herein, “a clerk,” “staff member,” “counter server,” and/or an “attendant” may be used interchangeably and synonymously herein and below. This refers to an individual who is operating an order/transaction manager of a transaction terminal to receive and fulfill orders at an in-store counter using the in-store ordering service discussed herein as system 100.

“An in-store counter” refers to a department or a customer service station where customers place orders for items of a store that are separately picked up by the customers before checking out of the store. Example, in-store counters may include bakeries, custom prepared food, custom prepared drinks, delis, custom printing, custom photo processing, and the like.

It is within this context that system 100 is now discussed with reference to FIG. 1.

System 100 comprises a cloud/server 110, a plurality of mobile devices 120, a plurality of transaction terminals 130, and one or more retail servers 140.

Cloud/Server 110 comprises at least one processor 111 and a non-transitory computer-readable storage medium 112. Medium 112 comprises executable instructions for an order estimator 113, an in-store order manager 114, and an Application Programming Interface (API). The executable instructions when provided to and executed by processor 111 from medium 112 cause processor 111 to perform the processing discussed herein and below for an order estimator 113, an in-store order manager 114, and API 115.

Each mobile device 120 comprises at least one processor 121 and a non-transitory computer-readable storage medium 122. Medium 122 comprises executable instructions for a mobile application (app) 123. The executable instructions when provided to and executed by processor 121 from medium 122 cause processor 121 to perform the processing discussed herein and below for app 123.

Each transaction terminal 130 comprises at least one processor 131 and a non-transitory computer-readable storage medium 132. Medium 132 comprises executable instructions for an order/transaction manager 133. The executable instructions when provided to and executed by processor 131 from medium 132 cause processor 131 to perform the processing discussed herein and below for order/transaction manager 133.

Each retail server 140 comprises at least one processor 141 and a non-transitory computer-readable storage medium 142. Medium 142 comprises executable instructions for a transaction system 143. The executable instructions when provided to and executed by processor 141 from medium 142 cause processor 141 to perform the processing discussed herein and below for transaction system 143. Medium 142 also comprises executable instructions for interfaces to search a transaction data store comprising transaction histories of customers of the retailer associated with server 140.

App 123 may a standalone new application provided by cloud/server 110 or may be an existing store shopping app enhanced by the teachings presented herein as an enhanced store shopping app 123.

App 123 provides a user-facing interface to a customer for which the customer can access interfaces screens and see available menu items from a given in-store counter of a given store and make selections or enter into fields specific special requests for items of an order. Other interfaces screens and options may show a saved shopping list of the customer for an order with the in-store counter. So, the interface screens permit browsing or entering order details of the in-store counter through interaction with the customer and permit recalling and display for any changes by the customer of a previously prepared shopping list of items representing the customer's order details.

The user-facing interface of app 123 also permits the customer to select an option to submit the order details (shopping list manually created in-store by the customer or previously prepared by the customer before the customer is at the store).

When the shopping list or order details are submitted, in-store order manager 114 receives the order details and obtains historical transaction information and real-time transactions using API 115 from transaction system 143. Based on pending orders being handled at the time the order was submitted for order/transaction manager 133 (obtained in the real-time transaction from transaction system 143) and based on metrics calculated for the historical transaction information (for the time of day, calendar day, and day of week), order estimator 113 calculates and estimated time for the order to be fulfilled by an attendant at the in-store counter. The estimated order completion time is provided back to app 123 by in-store order manager 114.

The user-facing interface of app 123 presents the estimated order completion time to the customer within a screen rendered on a display of device 120. The customer can then enter a specific time that the customer would like to pick up the order from the in-store counter or select an ASAP option, which will make the order available at the estimated order completion time if not sooner.

Once the customer selects either ASAP or a customer-selected pickup time that is on or after the estimated completion time, in-store order manager 114 uses API 115 to place the order with transaction system 143. When the order is received, order/transaction manager 113 displays the order queue to the attendants at the in-store counter and inserts the order into the order queue with a waiting status. Transaction system 143 also provides back to in-store order manager 114 through API 115 and order number being used by transaction system 143 to uniquely track the order and order details of the customer. In-store order manager 114 then sends a confirmation that the order with the order details was placed with the in-store counter to app 123. The user-facing interface of app 123 presents within a screen the order details, notification that the order was placed, and the order number, which was assigned by transaction system 143.

The customer is now free to shop about the store and their leisure and visit the in-store counter to pickup the order at the user-provided time or the estimated completion time. When an attendant accepts the order for fulfilling, order/transaction manager 133 changes the order status from waiting to in-progress and reports to transaction system 143. Transaction system 143 uses API 115 to notify in-store order manager with the order number and status update to an in-progress status. The user-facing interface of app 115 displays within a pop-up screen or an existing screen the order in-progress status for the customer's pending order. At this point, dependent upon the size or the details of the order, the customer may want to start making their way over to the in-store counter in preparation to pickup the order as soon as it is completed.

Similarly, when the order is fulfilled, the attendant operates interfaces of order/transaction manager 133 to change the status of the order to a completed status. This removes the order from the order queue and notifies transaction system 143 of the completed status for the corresponding order number. System 143 notifies in-store order manager 114 through API 115 that the order number has a completed status and is ready for customer pickup.

In-store order manager 114 sends a message to app 123 that the order is completed and ready for pickup by the customer at the in-store counter. The user-facing interface of app 123 presents within a popup or an existing screen an order ready for pickup message to the customer. The customer can finish whatever the customer is doing and head to the in-store counter knowing that the order is there and read for pickup.

In an embodiment, where the customer has preprepared a shopping list for an order with an in-store counter in advance of arriving at the store. App 123 utilizes location services of device 120 to report the location of device 120. When in-store order manager 114 identifies that the current location of device 120 is within a configured geofenced distance from the store associated with the in-store counter, in-store order manager 114 queries app 123 to see if any prepared shopping lists are available for the customer and if the answer is yes, the corresponding list is sent from app 123 to in-store order manager 114. Depending upon preferences set by the customer with app 123, the customer may be asked to confirm that the list associated with the order is to be submitted via the user-facing interface or the in-store order manager 114 may be instructed by app 123 to immediately place the order for the list. The customer preferences may also include a default customer-desired pickup time as ASAP (the estimated preparation time for the in-store counter). The customer may include no default pickup time in some cases, for which the estimated preparation times for the order and customer desired time may be presented to the customer through the user-facing interface of app 123.

In an embodiment, a shopping list preprepared by the customer within app 123 may include sub list of sub shopping list associated with the in-store counter. In-store order manager 114 identifies this sub list from the items of the shopping list without the customer specifically identifying the sub list that needs to be fulfilled by the in-store counter.

In an embodiment of the last embodiment, the overall shopping list of the customer within app 123 for a given store may includes a first set of items from the shopping list associated with a first in-store counter and a second set of items from the shopping list associated with a second in-store counter (e.g., bakery items and deli items). In-store order manager 114 processes each set of items with the corresponding counter as separate orders of the customer (e.g., one with the bakery in-store counter and one with the deli instore counter). The customer receives separate notifications through the user-facing interface of app 123 when the separate orders are fulfilled by the attendants of the in-store counters and ready for customer pickup.

In an embodiment, in-store order manager 114 interacts with transaction system 143 to determine when certain items in a customer order are unavailable. The customer is notified through the user-facing interface of app 123 along with any suggested alternatives that the customer may select to replace an out-of-stock item of their order. The customer uses the user-facing interface to make an alternative item for the order or revises the order details by removing the out-of-stock item. The customer may also cancel the order or revise the order in a manner desired by the customer based on the out-of-stock item.

In an embodiment, in-store order manager 114 interacts with transaction system 143 to confirm an estimated or an actual total item price for the customer order (estimated because some items may be sold by weight and an exact weight may not be know—for example two large tomatoes) before the customer affirmative submits the order through the user-facing interface of 123. The item detail and actual or estimated prices may also be presented to the customer before submitting the order with the transaction system 143.

In an embodiment, in-store order manager 114 may interact with app 123 to obtain any customer coupons to apply to the order held by the customer in a digital wallet of app 123. In-store order manager 114 provides the coupon codes to transaction system 143 for applying against a total transaction price. Details of the coupon may be reflected back to the customer in the item details for the order.

In an embodiment, the transaction terminal 130 is a Point-Of-Sale (POS) terminal or a digital sign or display with a touch-based input or a keyboard input for operation by the attendants of the in-store counter.

In an embodiment, mobile device 120 is a phone, a watch, a tablet computer, glasses, or a laptop computer.

In an embodiment, the order estimator 113, in-store order manager 114, and API 115 is subsumed into the processing environment and is processed on retail server 140.

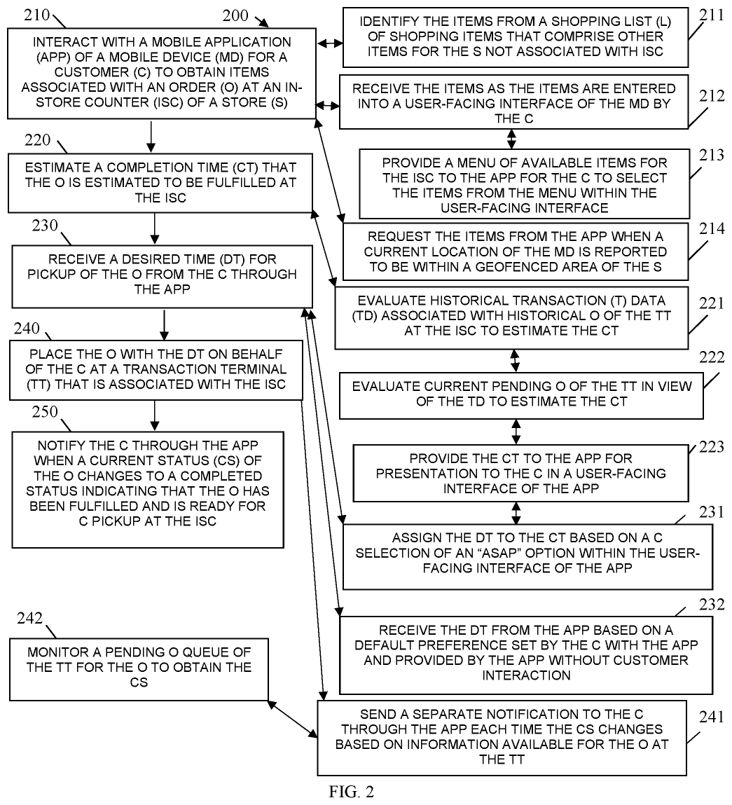

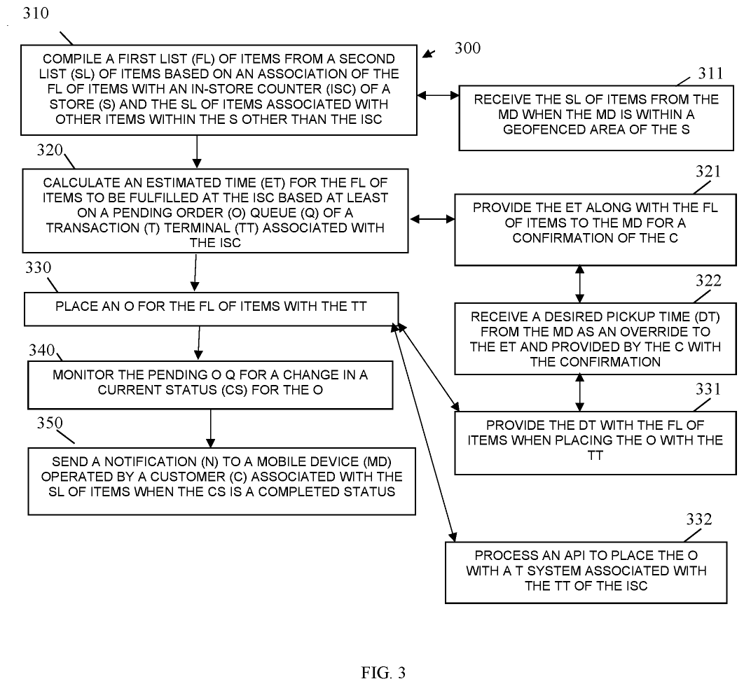

The above-referenced embodiments and other embodiments are now discussed within FIGS. 2-3.

FIG. 2 is a diagram of a method 200 for providing an in-store ordering service, according to an example embodiment. The software module(s) that implements the method 200 is referred to as an “in-store ordering service.” The in-store ordering service is implemented as executable instructions programmed and residing within memory and/or a non-transitory computer-readable (processor-readable) storage medium and executed by one or more processors of one or more devices. The processor(s) of the device that executes the in-store ordering service are specifically configured and programmed to process the in-store ordering service. The in-store ordering service may have access to one or more network connections during its processing. The network connections can be wired, wireless, or a combination of wired and wireless.

In an embodiment, the device that executes the in-store ordering service is cloud 110. Cloud 110 comprises a plurality of servers logically cooperating and accessible as a single server 110 (cloud 110).

In an embodiment, the device that executes the in-store ordering service is a server 110 that is separate from any given retail server 140.

In an embodiment, the device that executes the in-store ordering service is retail server 140.

In an embodiment, the in-store ordering service is all or some combination of 113, 114, and/or 115.

At 210, the in-store ordering service interacts with a mobile application (app) 123 of a mobile device 120 for a customer to obtain items associated with an order at an in-store counter of a store.

In an embodiment, at 211, the in-store ordering service identifies the items from a shopping list of shopping items that comprise other items from the store not associated with the in-store counter.

In an embodiment, at 212, the in-store ordering service receives the items (item identifiers) as the item identifiers are entered into a user-facing interface of the mobile application 123 of the mobile device 120 by the customer.

In an embodiment of 212 and at 213, the in-store ordering service provides a menu of available items for the in-store counter to the app 123 for the customer to select the item identifiers (items) from the menu within the user-facing interface of app 123.

In an embodiment, at 214, the in-store ordering service requests the items from the app 123 when a current location of the mobile device 120 is reported to be within a geofenced area of the store.

At 220, the in-store ordering service estimates a completion time that the order is estimated to be fulfilled at the in-store counter.

In an embodiment, at 221, the in-store ordering service evaluates historical transaction data associated with historical orders of the transaction terminal 130 at the in-store counter in order to estimate the completion time.

In an embodiment of 221 and at 222, the in-store ordering service evaluates current pending orders of the transaction terminal 130 in view of the historical transaction data to estimate the completion time.

In an embodiment of 222 and at 223, the in-store ordering service provides the completion time to the app 123 for presentation to the customer through the user-facing interface of the app 123.

At 230, the in-store ordering service receives a desired time for pickup of the order from the customer through the app 123.

In an embodiment of 223 and 230, at 231, the in-store ordering service assigns the desired time to the completion time based on a customer selection of an “ASAP” option within the user-facing interface of the app 123.

At 240, the in-store ordering service places the order with desired time on behalf of the customer at the transaction terminal 130 that is associated with or at the in-store counter.

In an embodiment, at 241, the in-store ordering service sends separate notifications to the customer through the app 123 each time a current status for the order changes based on information available for the order at the transaction terminal 130.

In an embodiment of 241 and at 242, the in-store ordering service monitors a pending order queue of the transaction terminal 130 to obtain the current status of the order.

At 250, the in-store ordering service notifies the customer through the app 123 when the current status of the order changes to a completed status indicating that the order has been fulfilled and is ready for customer pickup at the in-store counter.

FIG. 3 is a diagram of another method 300 for providing an in-store ordering service, according to an example embodiment. The software module(s) that implements the method 300 is referred to as an “in-store ordering manager.” The in-store ordering manager is implemented as executable instructions programmed and residing within memory and/or a non-transitory computer-readable (processor-readable) storage medium and executed by one or more processors of a device. The processors that execute the in-store ordering manager are specifically configured and programmed for processing the in-store ordering manager. The in-store ordering manager may have access to one or more network connections during its processing. The network connections can be wired, wireless, or a combination of wired and wireless.

In an embodiment, the device that executes the in-store ordering manager is cloud 110. In an embodiment, the cloud 110 is a collection of multiple servers cooperating as a single server 110.

In an embodiment, the device that executes the in-store ordering manager is a server 110 that is separate and apart from retail server 140.

In an embodiment, the device that executes the in-store ordering manager is retail server 140.

In an embodiment, the in-store ordering manager is all of or some combination of 113, 114, 115, and/or method 200.

The in-store ordering manager presents another and, in some ways, and enhanced processing perspective from that which was discussed above with cloud/server 110 and method 200 discussed above with FIGS. 1 and 2, respectively.

At 310, the in-store ordering manager complies a first list of items from a second list of items based on an association of the first list of items with an in-store counter of a store and the second list of items also associated with other items within the store other than the in-store counter.

In an embodiment, at 311, the in-store ordering manager receives the second list of items from the mobile device 120 of the customer when the mobile device 120 is within a geofenced area of the store.

At 320, the in-store ordering manager calculates an estimated time from the first list of items to be fulfilled (prepared) at the in-store counter based at least on a pending order queue of a transaction terminal 130 associated with the in-store counter.

In an embodiment, at 321, the in-store ordering manager provides the estimated time along with the first list of items to the mobile device 130 for a confirmation by the customer.

In an embodiment of 321 and at 322, the in-store ordering manager receives a desired pickup time from the mobile device 120 as an override to the estimated time and provided by the customer with the confirmation.

At 330, the in-store ordering manager places an order for the first list of items with the transaction terminal 130.

In an embodiment of 322 and 330, at 331, the in-store ordering manager provides the desired time with the first list of items when placing the order with the transaction terminal 130.

In an embodiment, at 332, the in-store ordering manager processes an API 115 to place the order with a transaction system 143 associated with the transaction terminal 130 of the in-store counter.

At 340, the in-store ordering manager monitors the pending order queue for a change in a current status of the order.

At 350, the in-store ordering manager sends a notification to the mobile device 120 operated by the customer associated with the second list of items and the order when the current status is determined to be a completed status at 340.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
interacting with a mobile application of a mobile device for a customer to obtain items associated with an order at an in-store counter of a store;
estimating a completion time that the order is estimated to be fulfilled at the in-store counter;
receiving a desired time for pickup of the order from the customer through the mobile application;
placing the order with the desired time on behalf of the customer at a transaction terminal that is associated with the in-store counter; and
notifying the customer through the mobile application when a current status of the order changes to a completed status indicating that the order has been fulfilled and is ready for customer pickup at the in-store counter.

2. The method of claim 1, wherein interacting further includes identifying the items from a shopping list of shopping items that comprise other items for the store not associated with the in-store counter.

3. The method of claim 1, wherein interacting further includes receiving the items as the items are entered into a user-facing interface of the mobile application.

4. The method of claim 3, wherein receiving further includes providing a menu of available items for the in-store counter to the mobile application for the customer to select the items from the menu within the user-facing interface.

5. The method of claim 1, wherein interacting further includes requesting the items from the mobile application when a current location of the mobile device is reported to be within a geofenced area of the store.

6. The method of claim 1, wherein estimating further includes evaluating historical transaction data associated with historical orders of the transaction terminal at the in-store counter to estimate the completion time.

7. The method of claim 6, wherein evaluating further includes evaluating current pending orders associated with the transaction terminal in view of the historical transaction data to estimate the completing time.

8. The method of claim 7, wherein evaluating further includes providing the completion time to the mobile application for presentation to the customer in a user-facing interface of the mobile application.

9. The method of claim 8, providing the completion time assigning the desired time to the completion time based on a customer selection of an “as soon as possible” option within the user-facing interface of the mobile application.

10. The method of claim 1, wherein receiving further includes receiving the desired time from the mobile application based on a default preference set by the customer with the mobile application and provided by the mobile application without customer interaction.

11. The method of claim 1, wherein placing further includes sending a separate notification to the customer through the mobile application each time the current status changes based on information available for the order at the transaction terminal.

12. The method of claim 11, wherein sending further includes monitoring a pending order queue of the transaction terminal for the order to obtain the current status.

13. A method, comprising:
compiling a first list of items from a second list of items based on an association of the first list of items with an in-store counter of a store and the second list of items associated with other items within the store other than the in-store counter;
calculating an estimate time for the first list of items to be fulfilled at the in-store counter based at least on a pending order queue of a transaction terminal associated with the in-store counter;
placing an order for the first list of items with the transaction terminal;
monitoring the pending order queue for a change in a current status for the order; and
sending a notification to a mobile device operated by a customer associated with the second list of items when the current status is a completed status.

14. The method of claim 13, wherein compiling further includes receiving the second list of items from the mobile device when the mobile device is within a geofenced area of the store.

15. The method of claim 13, wherein calculating further includes providing the estimated time along with the first list of items to the mobile device for a confirmation of the customer.

16. The method of claim 15, wherein providing further includes receiving a desired pickup time from the mobile device as an override to the estimated time and provided by the customer with the confirmation.

17. The method of claim 17, wherein placing further includes providing the desired pickup time with the first list of items when placing the order with the transaction terminal.

18. The method of claim 13, wherein placing further includes processing an Application Programming Interface (API) to place the order with a transaction system associated with the transaction terminal of the in-store counter.

19. A system, comprising:
a cloud processing environment comprising at least one server;
the at least one server comprising a processor and a non-transitory computer-readable storage medium;
the non-transitory computer-readable storage medium comprises executable instructions; and
the executable instructions when executed on the processor from the non-transitory computer-readable storage medium cause the processor to perform operations comprising:
identifying in-store counter items in a shopping list of items associated with an in-store counter of a store, wherein the shopping list is associated with a customer of the store;
estimating a completion time for the in-store counter items to be fulfilled at the in-store counter;
placing an order comprising the in-store counter items with a transaction system associated with the store;
monitoring a current status of the order through the transaction system based on a pending order queue maintained for a transaction terminal located at the in-store counter by the transaction system; and
sending notifications to a mobile device operated by the customer when the current status of the order changes.

20. The system of claim 19, wherein the executable instructions associated with the placing further cause the processor to perform additional operations comprising:
placing the order with a desired pickup time that exceeds the completion time based on an override provided by the customer through a user-facing interface of the mobile device.
